(19) United States
(12) Patent Application Publication
(10) Pub. No.: US 2015/0026984 A1
(43) Pub. Date: Jan. 29, 2015

(54) DETECTION OF CUT LITZ WIRES

(71) Applicant: Schäfer Werkzeug-und Sondermaschinenbau GmbH, Bad Schönborn-Langenbrücken (DE)

(72) Inventors: Stefan Neubauer, Otterstadt (DE); Markus Schäfer, Bad Schoenborn (DE)

(73) Assignee: Schafer Werkzeug-und Sondermaschinenbau GmbH, Bad Schonborn-Langenbrucken (DE)

(21) Appl. No.: 14/358,098

(22) PCT Filed: Nov. 7, 2012
(86) PCT No.: PCT/EP2012/072008

§ 371 Date: Sep. 16, 2014

(30) Foreign Application Priority Data
Nov. 14, 2011 (DE) 202011107872.1

(51) Int. Cl. H02G 1/12

(52) U.S. Cl. CPC H02G 1/1253
USPC 30/90.1; 30/346

(57) ABSTRACT

The present invention relates to stripping devices by way of which a cable sheath can be removed from a cable end and in this way the cable core can be exposed. Such a stripping device for stripping a cable sheath from a cable comprises a first cutter half and a second cutter half which are movable towards one another in a first direction. The mutually facing lateral surfaces of the first and second cutter halves are spaced apart from one another at a spacing in a second direction substantially perpendicular to the first direction, and a voltage is applied to the first cutter half and the second cutter half. Furthermore, the stripping device has an evaluation unit connected to the first cutter half and the second cutter half, said evaluation unit being able to detect a current flow through the first cutter half and/or the second cutter half (10).

### TECHNICAL FIELD

The present invention relates to stripping devices with which a cable sheath can be removed from a cable end and in this way the cable core can be exposed.

### STATE OF THE ART

In the field of stripping devices, such are known which have two V-shaped cutter halves lying opposite one another. During the stripping operation, these cutter halves are moved towards one another and pressed through the insulation. Afterwards, the cutter halves are each moved in a direction opposite to this forward motion, but remain engaged with the cable sheath. In the following method step, the cutter halves are moved in a direction parallel to the longitudinal direction of the cable in order to strip off the cable sheath.

However, there is the problem that the cutter halves penetrate the cable too deeply during stripping, for example due to variations in quality of the cables or due to a non-precise alignment of the cables relative to the cutter halves. Thus, there is the risk that stranded wires of the cable core are damaged by the cutting surfaces of the cutter halves. Should a stranded wire be cut through by this operation and should it also be stripped off when the cable sheath is stripped off, this defective cable has a cable core which differs as to the diameter and the shape of the diameter from cable cores which have remained undamaged during stripping. This has the effect that the required crimping force is no longer applied during the subsequent crimping of the cable core with a crimping element and that therefore a defective connection is produced between the cable core and the crimping element.

If the stripped cable is an aluminum conductor, the fact that one of the cutter halves cuts into the cable core also leads to a problem that the protective oxide layer of the aluminum is removed with the cutter and a corrosion of the cable core takes place at this point. This in turn can lead to a defective crimp connection during crimping or also at a later time.

### THE SUBJECT MATTER OF THE INVENTION

It is an object of the present invention to solve the aforementioned problems and to ensure the quality of crimp connections already when stripping the cable ends.

The object according to the invention is solved by a device according to claim 1 and by a cutter half according to claim 11. Furthermore, a device according to claim 12 is provided. Further advantageous embodiments are described in the dependent claims.

The central idea of the present invention is to monitor stripping during the entire stripping operation by applying a voltage to the cutter halves used for stripping. Should the cutter halves come into contact with the cable core, an electric circuit is closed and thus it is indicated that a defective cable end is to be expected. Consequently, such a cable is sorted out such that no defective cables move to the subsequent crimping operation.

The present invention provides for this a stripping device for stripping a cable sheath with a first cutter half and a second cutter half. The cutter halves are movable in a first direction (for example in a vertical direction). In particular, the cutter halves for stripping a cable sheath can be moved towards one another. The mutually facing lateral surfaces of the first and second cutter halves are spaced apart from one another at a spacing in a second direction (for example in a horizontal direction) substantially perpendicular to the first direction. By this spacing, it is ensured that the cutter halves can optionally sectionally overlap without engaging with each another, even if the cutter halves are deformed during stripping or when stripping off the cable sheath. A voltage is applied to the first and second cutter halves made of a conductive material. Furthermore, the stripping device has an evaluation unit connected to the first cutter half and the second cutter half, which is able to detect a current flow through the first cutter half and the second cutter half. It is particularly preferred here that this is a current flow between the two cutter halves. As a further objective, a current flow through the first cutter half and/or the second cutter half could be detected by the evaluation unit.

In this way, it can be detected whether the cutter halves contact the cable core and thus optionally separate stranded wires from the cable core. Such a detection can be carried out by the evaluation unit during stripping. Accordingly, this is a simple technical measure by which the manufacturing process is not extended. Since the evaluation unit operates fully automatically, further measures for assuring the quality of a possible “cut stranded wire” are not necessary.

According to one embodiment, the cutter halves each have a V-shaped cutting edge. In this way, a cable can be cut from plural sides. Thus, stripping can be carried out in a simple and safe manner.

According to a further embodiment, terminals are attached to the cutter halves or are integrally configured with the cutter halves, via which the evaluation unit is connected to the respective cutter half. If these are “standard cutter halves” used without the detection of damage to the cable core described here, such a contact could be clamped on, for example.

In one embodiment, the insulation is formed substantially L-shaped such that a longitudinal section of the insulation abuts a lateral surface of the cutter half and a lateral section abuts a rear surface of the cutter half. Thus, the conductive cutter half is insulated from the usually metallic holder, by means of which measuring errors cannot occur at this point. For example, the insulation can be made of a ceramic material, which ensures the positional accuracy of the cutter half.

In another embodiment, the insulation is formed as a coating, for example a ceramic coating, of a section of the first cutter half and/or the second cutter half. This insulation also ensures that the conductive cutter halves are separated from the respective holder. In yet another embodiment, the first and/or the second cutter half has a recess into which the insulation formed as a block is inserted and fixed, with the insulation protruding beyond a lateral surface of the respective cutter half. By this protrusion of the insulation, the respective cutter half can be spaced apart from the holder such that a particular spacing is formed between the two cutter halves in the second direction.

Moreover, cutter halves can be provided which have offset sections which in the installed state of the respective cutter half face in the direction of the other cutter half and towards a lateral surface of this cutter half. However, it is possible to reduce the spacing between the cutter halves in the second direction and to simultaneously ensure that no contact is established between the cutter halves when the cable sheath is stripped off and the cutter halves are slightly bent. This would have the effect that a defective cable was incorrectly assumed.

In a further embodiment, a stripping device is provided which has plural first cutter halves (as well as plural second cutter halves). With such a device, plural cables can be stripped in parallel by a common lifting and stripping-off movement of the cutter halves.

Furthermore, the evaluation unit can additionally be connected to the cable core of the cable to be worked. In this way, a contact of a cutter half with the cable core can be detected. The result of this detection can have the effect, for example, that this cable is sorted out since there may be a damage.

It is also conceivable to carry out a 2-step test, namely (1) to contact one cutter half with the cable core, and (2) to contact both cutter halves with the cable core. In step (1), a current flow occurs between one cutter half and the cable core; in step (2), an additional current flow occurs between the two cutter halves. This could be particularly preferably incorporated into a method.

It is conceivable thereby to make a decision with the described test on the basis of the material type of the cable core as to whether there is a defective stripped cable.

According to a further objective of the present invention, a stripping device is provided for stripping a cable sheath from a cable with a first cutter half and a second cutter half which are movable towards one another in a first direction (Y). The mutually facing lateral surfaces of the first and second cutter halves are spaced apart from one another at a spacing in a second direction (X) substantially perpendicular to the first direction, a voltage is applied to the first cutter half and the second cutter half, and the stripping device furthermore has an evaluation unit connected to the first cutter half and the second cutter half, which is able to detect a current flow through the first cutter half and/or the second cutter half, with an insulation of the first and/or second cutter half being formed substantially L-shaped such that a longitudinal section abuts a lateral surface of the cutter half and a lateral section abuts a rear surface of the cutter half.

The stripping device according to this objective can be combined with aforementioned embodiments in order to form new embodiments.

### BRIEF DESCRIPTION OF THE DRAWINGS

FIG. 1 shows a schematic sectional view of two extended cutter halves;

FIG. 2 shows a further embodiment of two extended cutter halves;

FIG. 3a shows a top view of a cutter half fixed to a holder;

FIG. 3b shows a top view of an alternative embodiment of a cutter half according to the present invention;

FIG. 4 is a schematic illustration of a stripping aggregate for stripping three cable ends;

FIG. 5 shows a diagram which illustrates a forward motion of one of the cutter halves when stripping a cable end.

### DETAILED DESCRIPTION OF THE PREFERRED EMBODIMENTS

Against the background of the enclosed figures, preferred embodiments of the present invention and the modifications thereof are described below as mere examples. Individual features of the described variants can be combined with each other in order to form new embodiments.

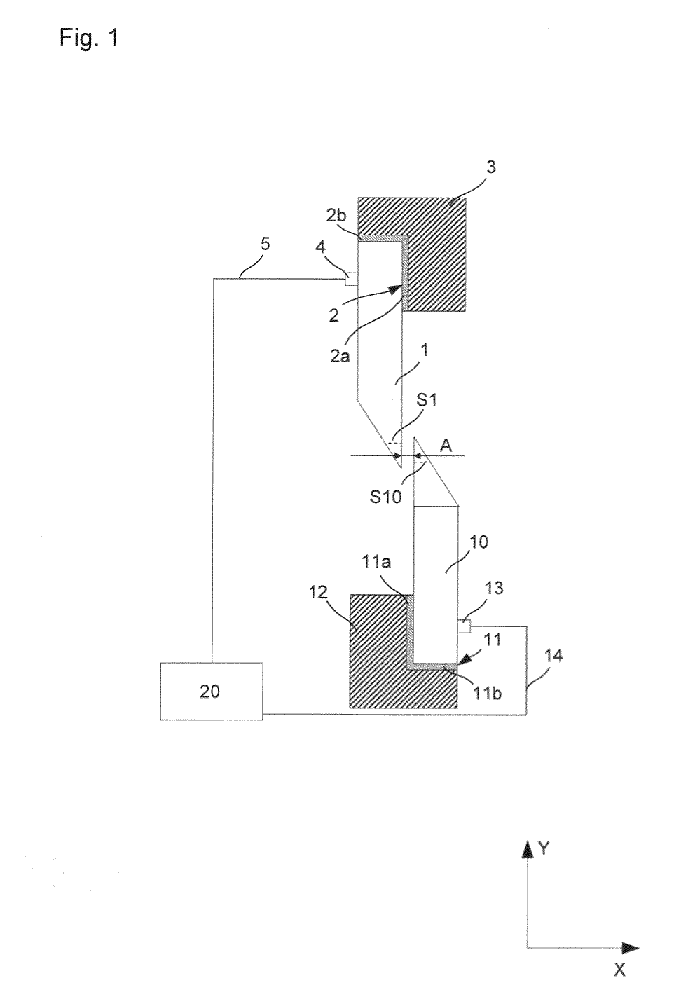

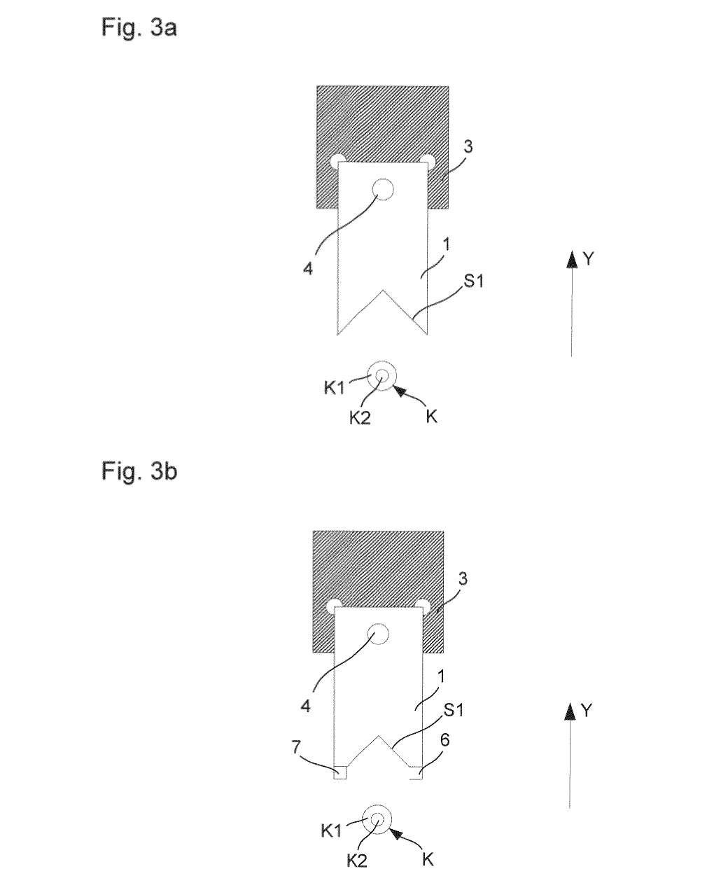

FIG. 1 shows a first cutter half 1, the geometry of which is described more exactly below with reference to FIGS. 3a and 3b. The first cutter half 1 is provided with an insulation 2, via which the first cutter half 1 is attached to a holder 3 and is insulated from this holder.

A second cutter half 10 is provided in a manner substantially mirroring the first cutter half 1, which is also connected to a holder 12 via an insulation 11. The insulations 2, 11 can, for example, be screwed on, adhered to or in another manner fixedly connected to the respective holder.

The holders 3 and 12 are movable towards one another, by which the cutter halves 1, 10 are sectionally guided past one another. A spacing A is formed here between the cutter halves 1, 10 between a lateral surface of the cutter 1 and a lateral surface of the second cutter 10.

In FIG. 1, the cutter halves 1, 10 made of a conductive material (for example a metal) are shown in an extended position. Since the cutter halves have V-shaped cutting edges S1, S10 (see also FIGS. 3a, 3b), a rhombic gap is formed when looking at the cutter halves 1, 10 from above, which at least a cable core can penetrate. In contrast, in an extended state of the cutter halves, the cable sheath is at least sectionally penetrated by the cutting edges S1, S10.

On the first cutter half 1, a terminal 4 is provided on a lateral surface facing away from the holder 3, on which voltage can be applied to the conductive cutter half 1 via an electrical cable 5. A terminal 13 is also provided on the second cutter half 10 on a lateral surface facing away from the holder 12, on which voltage can be applied to the metallic second cutter half 10 via an electrical cable 14.

The terminals 4, 13 can with this be screwed on, welded on, soldered on or clamped on the cutter halves 1, 10. Alternatively, it is possible to provide cutter halves with an integral terminal for an electrical cable.

The electrical cables 5, 13 are connected to an evaluation unit 20. The evaluation unit 20 can evaluate whether a current is flowing through the electrical cables 5, 13, which indicates that a contact has been established between the cutter halves 1, 10 via the cable core K2.

Alternatively or additionally, it is possible to connect the evaluation unit to the cable core K2 as well. Although in particular with a symmetrical configuration of the cutter halves both cutter halves penetrate the insulation equally far and thus contact the cable core substantially simultaneously, it could happen that only one cutter half penetrates too far. In this case, the current would flow through the further penetrating cutter half and through the cable core. This could also be detected.

The cutter halves 1, 10 are each connected to the respective holder 3, 12 by means of an insulation 2, 11. In the embodiment shown in FIG. 1, the insulation 2, 11 is formed substantially L-shaped. The insulation 2 has a longitudinal section 2a which abuts a lateral surface of the first cutter half 1, and the insulation 2 has a lateral section 2b which is in contact with an end side of the first cutter half 1. The lateral section has such a thickness that the spacing A shown in FIG. 1 is half-formed (½×A). By this configuration, it is ensured that neither the end side of the first cutter half 1 nor the lateral surface thereof comes into contact with the holder 3. Otherwise, a voltage would be applied to the holders 3, 12 as well.

The spacing can be 0.001 mm, for example. This ensures sufficient shear forces and prevents a contact between the cutter halves. Other spacings, for example in the range of 0.00005≦A≦0.01 mm, are conceivable depending on the deformation resistance of the cutter halves.

The insulation 11 of the second cutter half 10 is formed corresponding to the insulation 2 and also has a longitudinal section 11a and a lateral section 11b, which are in contact with a lateral surface and a rear surface of the second cutter half 10 and the holder 12. The insulation prevents a contact between the second cutter half 10 and the holder 12.

In the end, it is ensured in this way that the current flow monitored by the evaluation unit 20 is not produced via the stripping aggregate.

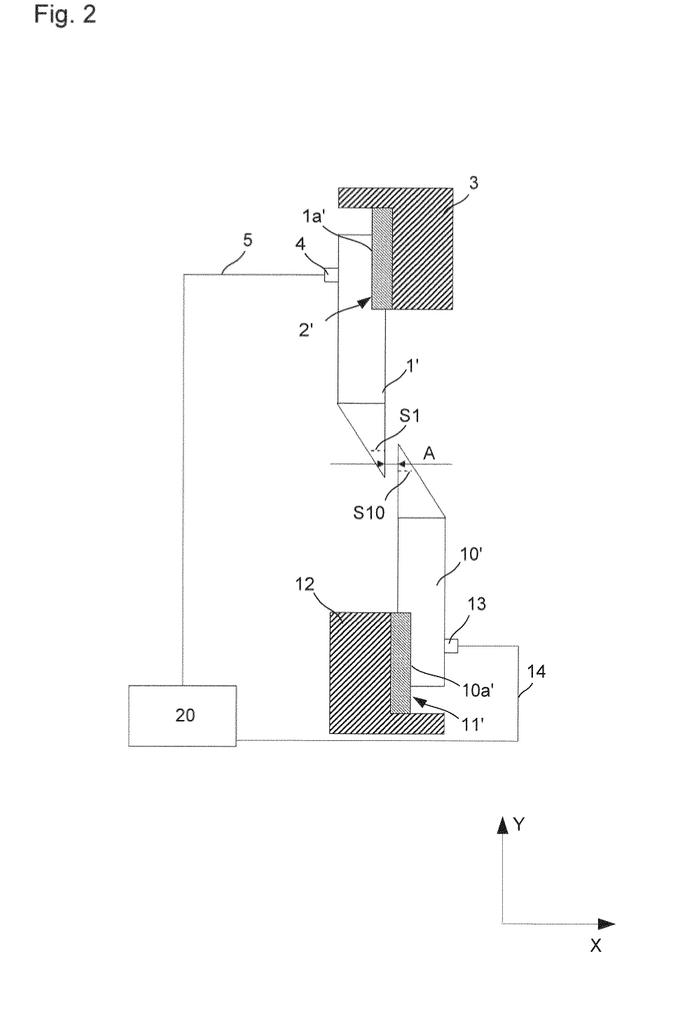

In FIG. 2, a further embodiment of the present invention is shown with a first cutter half 1′ and a second cutter half 10′. The insulations 2′, 11′ are incorporated into recesses 1a′, 10a′ on a lateral surface of the first cutter half 1′, with the insulations 2′, 11′ protruding beyond the lateral surfaces of the cutter halves 1′, 10′. The protrusion is provided such that the spacing A shown in FIG. 2 is half-formed each (½×A).

The insulations are attached to the cutter halves 1′, 10′ by means of screw connections, for example. Furthermore, it is provided that the first cutter half 1′ on a rear surface does not abut the holder 3, rather a sufficient spacing from the holder 3 is provided.

In FIG. 3a, a top view of the first cutter half 1 is shown which is fixedly connected to the holder 3. The V-shaped cutting surface S1 is shown here, which is used for cutting through the cable sheath. In FIG. 3a, the first cutter half 1 is shown in a state in which the cutter halves 1, 10 are not in contact with the cable K.

FIG. 3b shows a further variant of a cutter half 1″, in which two offset sections 6, 7 are provided in addition to the cutting edge S1. In the area of these offset sections 6, 7, sliding blocks can be attached or a coating applied, which consist of a non-conductive material. In this way, it is ensured that, when the cable sheath K1 is stripped from the cable core K2, the first and second cutter halves 1″, 10″ do not produce a conductive connection when contacting one another. Such a contact can occur when the spacing A is selected to be very short and when the first and second cutter halves are bent when the cable sheath is stripped off during stripping.

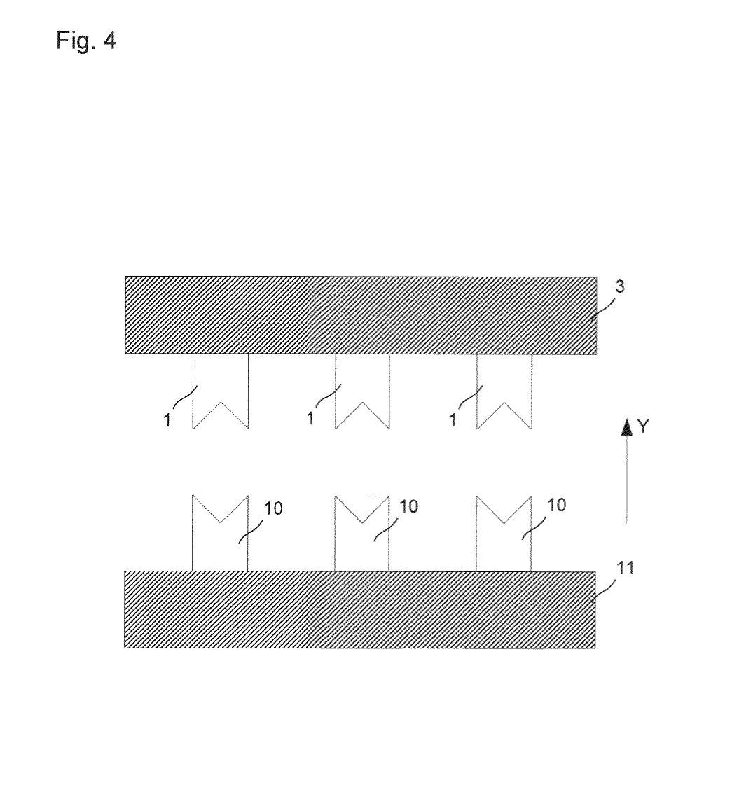

FIG. 4 schematically shows a stripping device having plural first cutter halves 1 as well as plural second cutter halves 10. With such a device, plural cable ends can be stripped simultaneously in one operation by moving the first cutter halves 1 and the second cutter halves 10 towards one another and by subsequently extending them in a direction parallel to the longitudinal direction of the cables K.

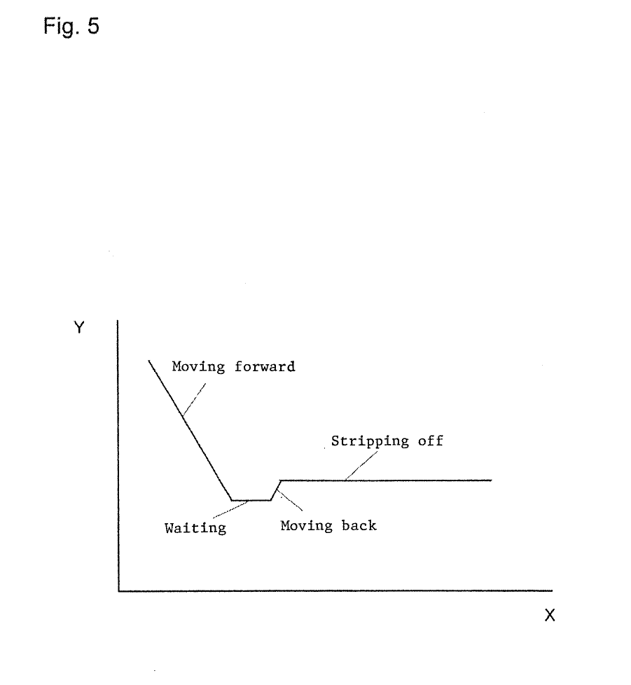

In FIG. 5, a diagram is shown which illustrates the movement of the first and second cutter halves 1, 10 (or 1′, 10′), with the first and second cutter halves 1, 10 being moved towards one another.

The stripping operation is divided here into four phases. First, the cutter halves 1, 10 are moved forward, thereby penetrating the cable sheath K1. After moving forward, the cutter halves 1, 10 remain in this position for a short time such that the cutting edges S1, S10 can safely penetrate the cable sheath K1. This is advantageous since the cable sheath K1 consists of an elastic material and recedes during the forward motion without being cut through. Subsequently, the cutter halves 1, 10 are moved back by a shorter distance and in this position are then shifted in a direction parallel to the longitudinal direction of the cable K. In this way, the cable sheath K1 is stripped from the cable core K2.

Thus, a preferred method for stripping is as follows: Moving forward cutter halves 1, 10 such that a cable sheath K1 is sectionally cut through, moving the cutter halves 1, 10 in a direction parallel to the longitudinal direction of the cable K and detecting a current flow between the first cutter half 1 and the second cutter half 10. If a current flow is detected between the first cutter half 1 and the second cutter half 10, it is determined that the stripping operation was defective.

Furthermore, it is preferred that the cutter halves 1, 10 are moved back by a short distance (moved away from one another) before they are moved in a direction parallel to the longitudinal direction of the cable K. Before this step, however, the cutter halves can be held in their position for a defined period of time. In this way, the cable sheath K1 is safely cut through which, due to the elastic material, recedes a bit when the separation movement is carried out.

1. A stripping device for stripping a cable sheath from a cable, comprising a first cutter half and a second cutter half which are movable towards one another in a first direction;
the mutually facing lateral surfaces of the first and second cutter halves are spaced apart from one another at a spacing in a second direction substantially perpendicular to the first direction,
a voltage is applied to the first cutter half and the second cutter half, and
the stripping device furthermore has an evaluation unit connected to the first cutter half and the second cutter half, which is able to detect a current flow through the first cutter half and the second cutter half.

2. A stripping device according to claim 1, in which the first cutter half and the second cutter half each have a V-shaped cutting edge.

3. A stripping device according to claim 1, in which terminals are attached to the cutter halves or are integrally configured with the cutter halves, via which the evaluation unit is connected to the respective cutter half.

4. A stripping device according to claim 1, in which an insulation of the first and/or second cutter half is formed substantially L-shaped such that a longitudinal section abuts a lateral surface of the cutter half and a lateral section abuts a rear surface of the cutter half.

5. A stripping device according to claim 1, in which an insulation of the first and/or second cutter half is formed by a coating of a section of the first cutter half and/or the second cutter half.

6. A stripping device according to claim 1, in which the first cutter half and/or the second cutter half has a recess, into which the insulation formed as a block is inserted and fixed, the insulation protruding beyond a lateral surface of the cutter half.

7. A stripping device according to claim 1, in which the first cutter half having a first insulation is formed substantially equal to the second cutter half having a second insulation.

8. A stripping device according to claim 1, in which the first cutter half and the second cutter half have two offset sections with an insulating coating, in which sections the first cutter half and the second cutter half sectionally contact each other when the cable sheath is stripped off.

9. A stripping device according to claim 1, which has plural first cutter halves as well as plural second cutter halves.

10. A stripping device according to claim 1, in which the evaluation unit is connected to the cable core (K2) of the cable (K) to be worked.

11. A cutter half for a stripping device according to claim 1, to which cutter half a voltage can be applied via a terminal, the cutter half preferably having a V-shaped cutting edge.

12. A stripping device for stripping a cable sheath from a cable, comprising a first cutter half and a second cutter half which are movable towards one another in a first direction;
the mutually facing lateral surfaces of the first and second cutter halves are spaced apart from one another at a spacing in a second direction substantially perpendicular to the first direction,
a voltage is applied to the first cutter half and the second cutter half, and
the stripping device furthermore has an evaluation unit connected to the first cutter half and the second cutter half, which is able to detect a current flow through the first cutter half and/or the second cutter half, an insulation of the first and/or second cutter half being formed substantially L-shaped such that a longitudinal section abuts a lateral surface of the cutter half, and a lateral section abuts a rear surface of the cutter half.

13. A stripping device according to claim 12, in which the insulation of the first and/or second cutter half is formed by a coating of a section of the first cutter half and/or the second cutter half.

14. A stripping device according to claim 12, in which the first cutter half and/or the second cutter half has a recess into which the insulation formed as a block is inserted and fixed, the insulation protruding beyond a lateral surface of the cutter half.

15. A stripping device according to claim 12, in which the first cutter half and the second cutter half have two offset sections with an insulating coating, in which sections the first cutter half and the second cutter half sectionally contact each other when the cable sheath is stripped off.
